(19) United States
(12) Patent Application Publication
(10) Pub. No.: US 2008/0243912 A1
(43) Pub. Date: Oct. 2, 2008

(54) Method of providing business intelligence

(75) Inventors: Behnam Azvine, Ipswich (GB); Detlef Daniel Nauck, Ipswich (GB); Martin Winfried Spott, Ipswich (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNCTIONS public limited company, London (GB)

(21) Appl. No.: 11/727,895

(22) Filed: Mar. 28, 2007

(51) Int. Cl. G06F 17/30

(52) U.S. Cl. 707/103 R

(57) ABSTRACT

The present invention provides a method of determining business intelligence in real time. A business process or operation can be defined by a number of inter-related business entities. The inter-relationship between the values associated with each business entity can be determined such that the values of strategic objectives, such as customer satisfaction, can be determined in accordance with changes in operational parameters, for example the number of active engineers, or external factors, such as the rate that calls are made to a help line.

The present invention relates to a method of monitoring business processes and in particular to a method of providing business intelligence in real time.

Business intelligence is a management term that is often used to describe the technology and applications that allow managers to monitor and analyse the performance of their business and the individual processes that are a part of their business operations. Whilst it is relatively straightforward to measure a process parameter such as, for example, the number of engineers on duty at a given time or the time taken to fix a fault, it is more difficult, and expensive, to determine a value for more complex and subjective factors such as customer satisfaction. Furthermore, it is difficult to establish and quantify a link between the lower level parameters, for example the time taken to fix a fault, and the higher level objectives, for example quality or customer satisfaction, and how the value of the higher level objectives might vary in response to variations in the lower level parameters. It is also important to be able to account for variations in external factors, such as customer demand or the weather, that are beyond the control of a business organisation.

According to a first aspect of the present invention there is provided a method of determining the performance of a business process, the method comprising the steps of: a) determining the plurality of business entities that comprise said business process; b) for each of said plurality of business entities, identifying a relationship between said business entity and one or more further business entities from said plurality of business entities; c) for each of said plurality of business entities and for each relationship identified in step b), determining a relationship between said business entities; d) for one or more of said plurality of business entities, allocating a data value for said one or more business entities; and e) determining the performance of said business process performance from the data values assigned to said one or more business entities in step d) and business entity relationships determined in step d).

According to a second aspect of the present invention there is provided a computer program product comprising computer executable code for carrying out the method described above.

According to a third aspect of the present invention there is provided a system for of determining the performance of a business process, the system comprising; one or more data storage means, said data storage means comprising data representing the value of each of a first plurality of business entities; business logic means, said business logic means comprising data representing the value of each of a second plurality of business entities and a plurality of relationships between each business entity and one or more further business entities of said first plurality of business entities and/or one or more further business entities of said second plurality of business entities, wherein, in use, said value of each of said second plurality of business entities is derived from evaluating each of said relationships for each of said second plurality of business entities; and wherein, in use, the performance of said business process is determined in accordance with said value of each of said second plurality of business entities.

The present invention will now be described with regard to the following Figures, in which are shown, by way of example only:

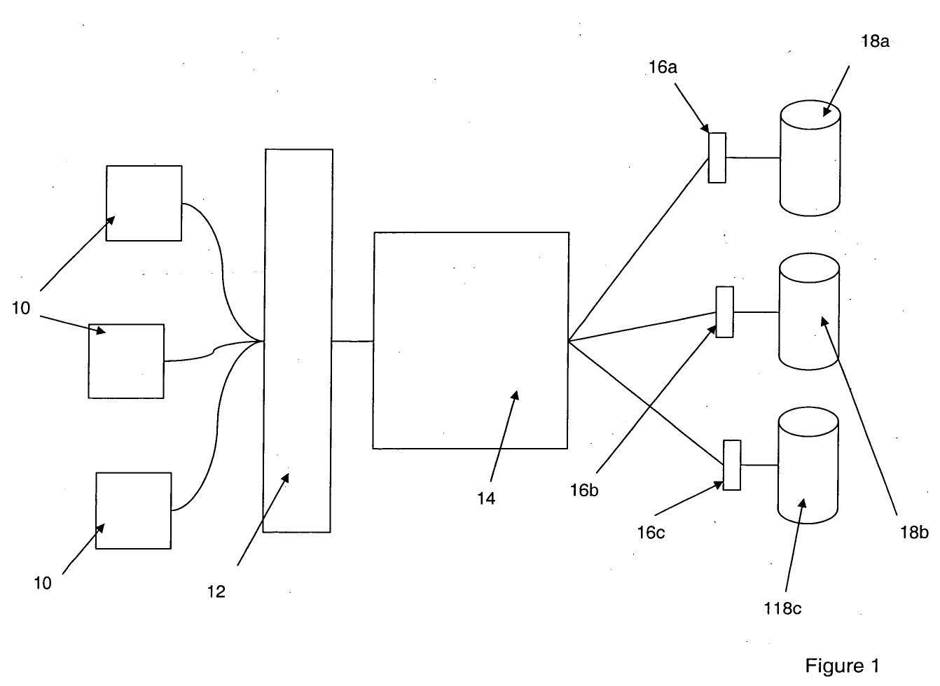

FIG. 1 shows a schematic depiction of a simplified arrangement of a system according to the present invention;

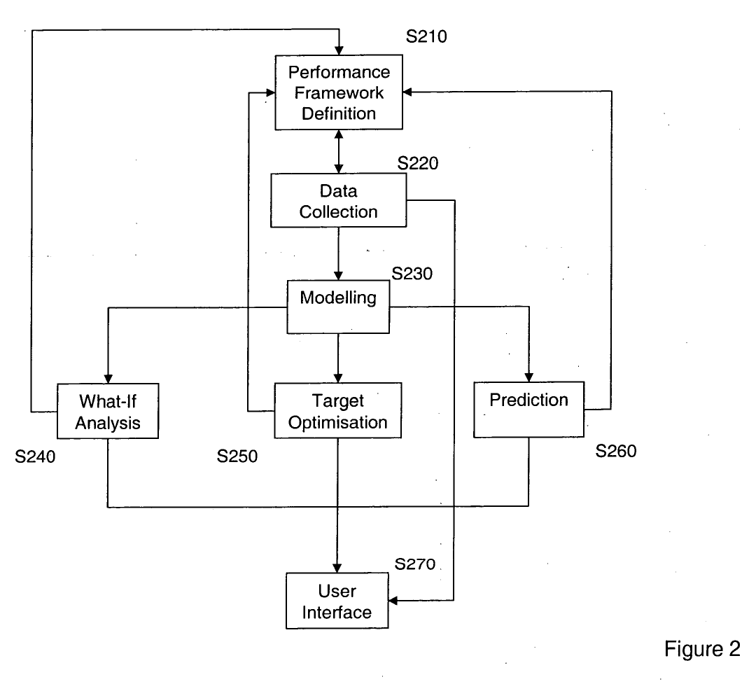

FIG. 2 shows a flowchart that sets out the processes that are carried out by the system according to FIG. 1;

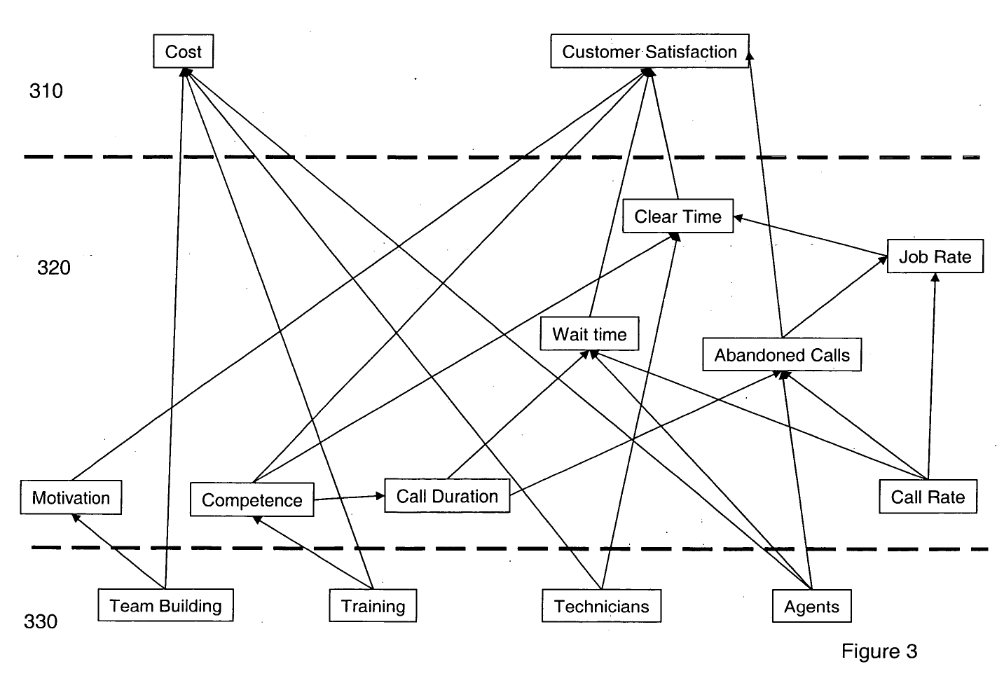

FIG. 3 shows an example of a framework chart that describes a process that is carried out within a call centre;

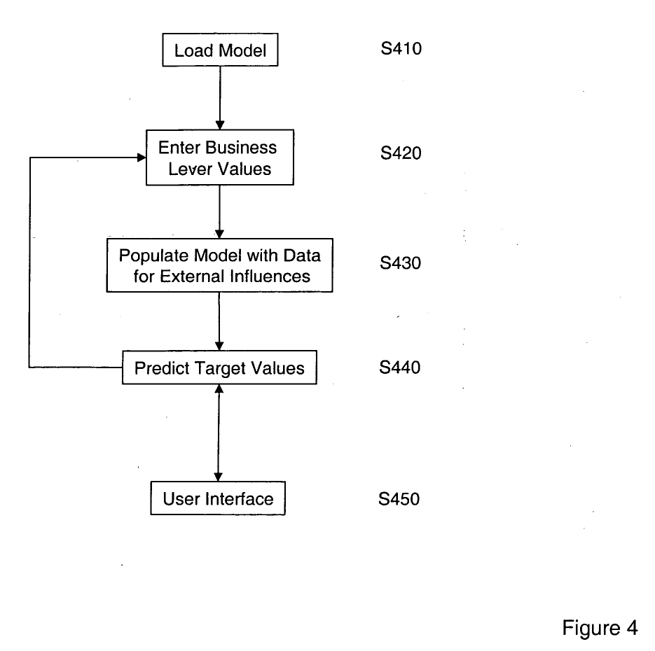

FIG. 4 shows a flowchart that descries the processes involved when a system according to the present invention is used to predict the performance of a business process;

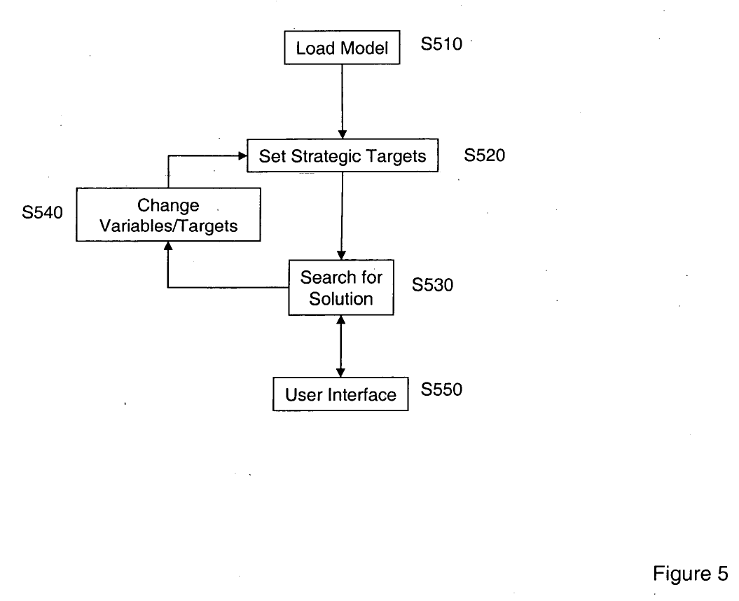

FIG. 5 shows a flowchart that describes the processes involved when a system according to the present invention is used to optimise the performance of a business system or process;

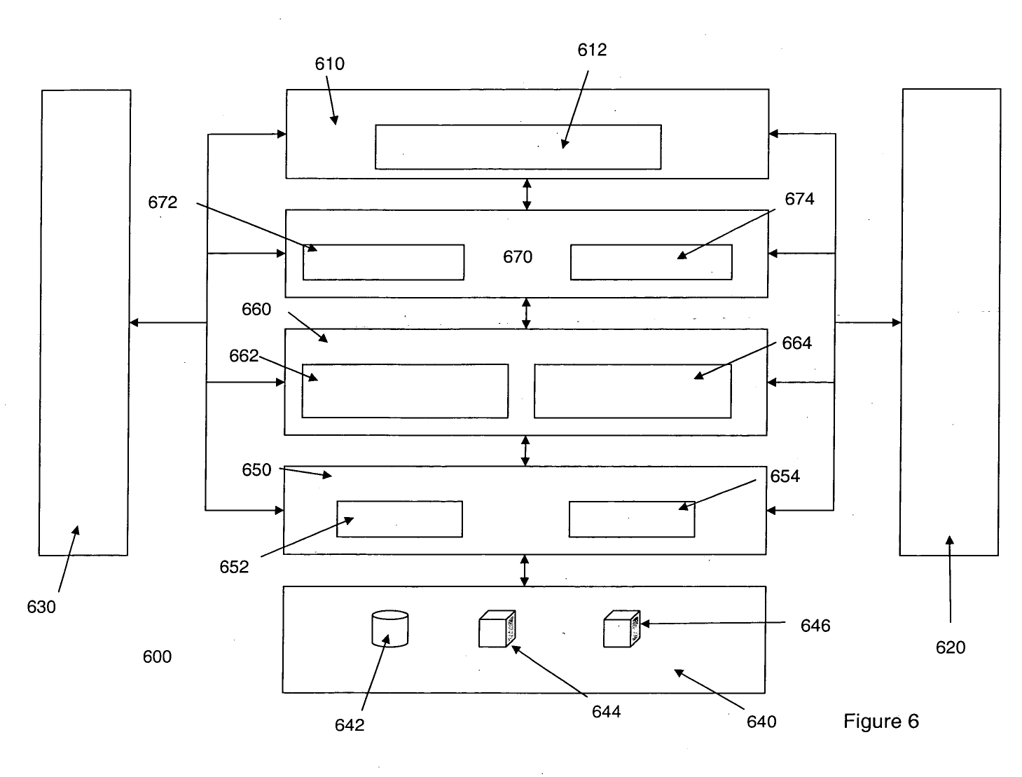

FIG. 6 shows a schematic depiction of the interrelated software layers that define the operation of a system according to a further embodiment of the present invention;

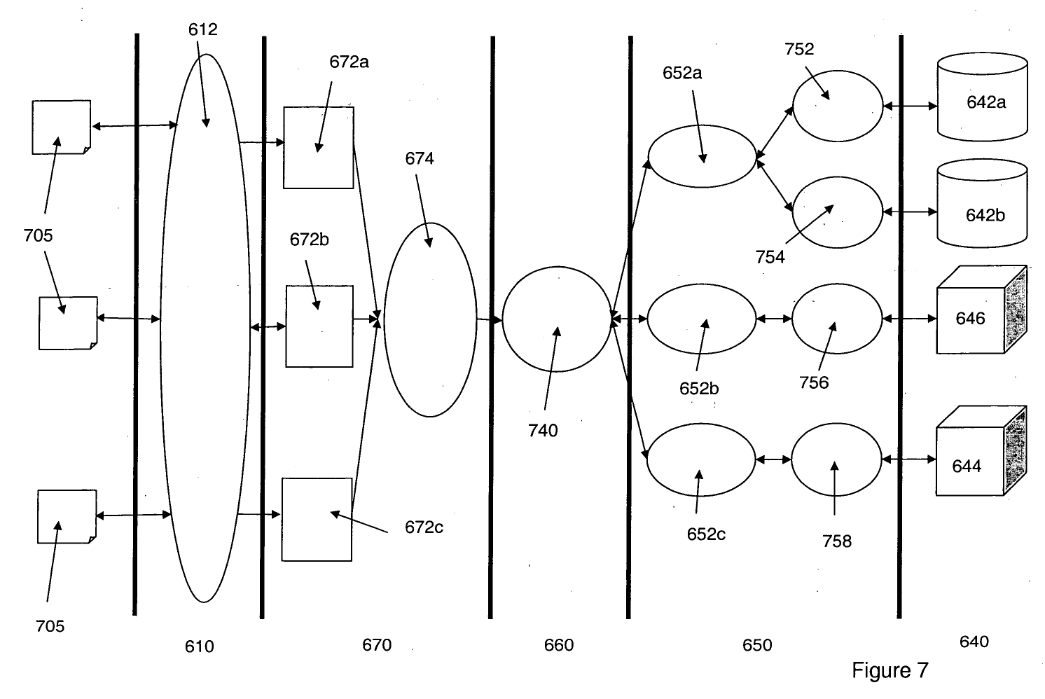

FIG. 7 shows a schematic depiction of the architecture of the system depicted in FIG. 6;

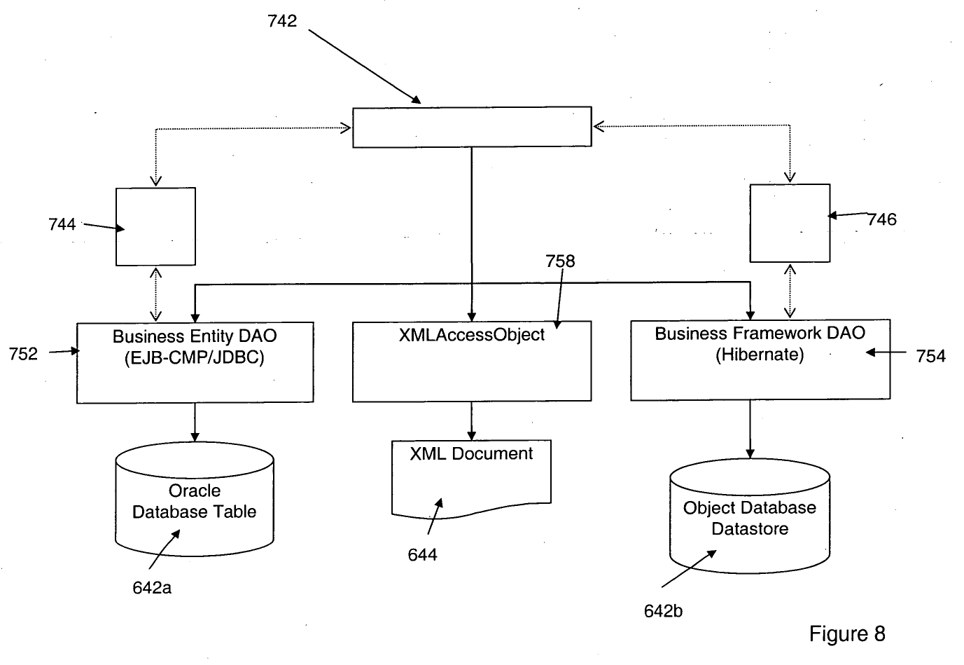

FIG. 8 shows a data access pattern that is used in the system depicted in FIG. 6;

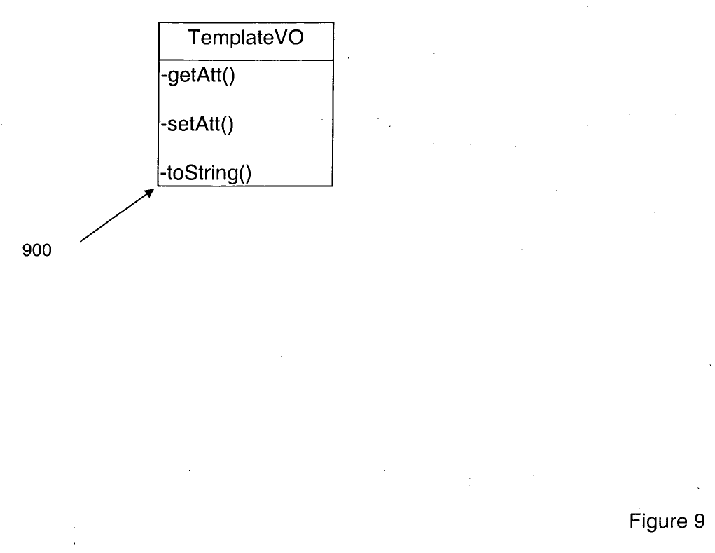

FIG. 9 shows a typical value object pattern that is used in the system depicted in FIG. 6;

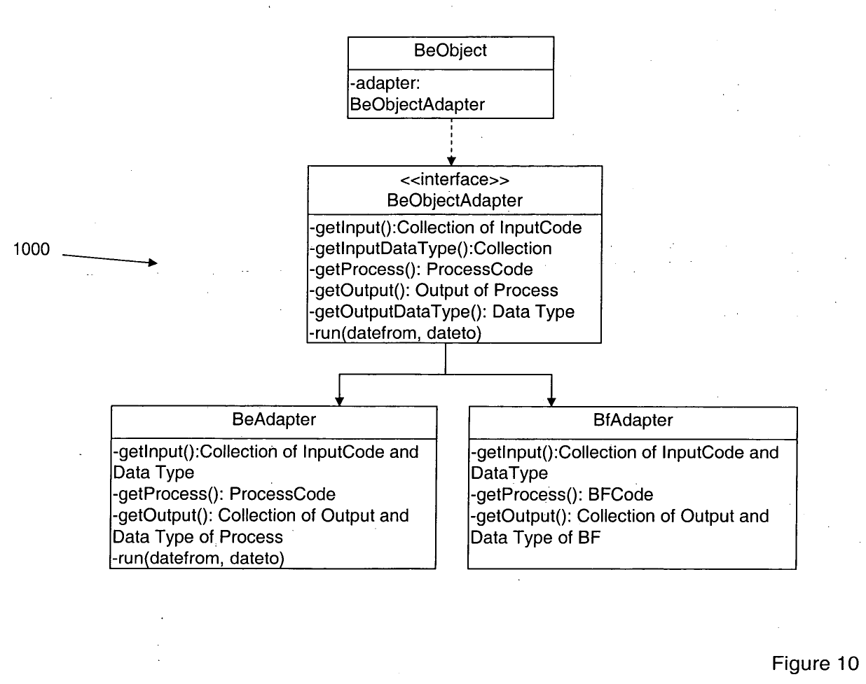

FIG. 10 shows the pattern for a business object that is used in the system depicted in FIG. 6;

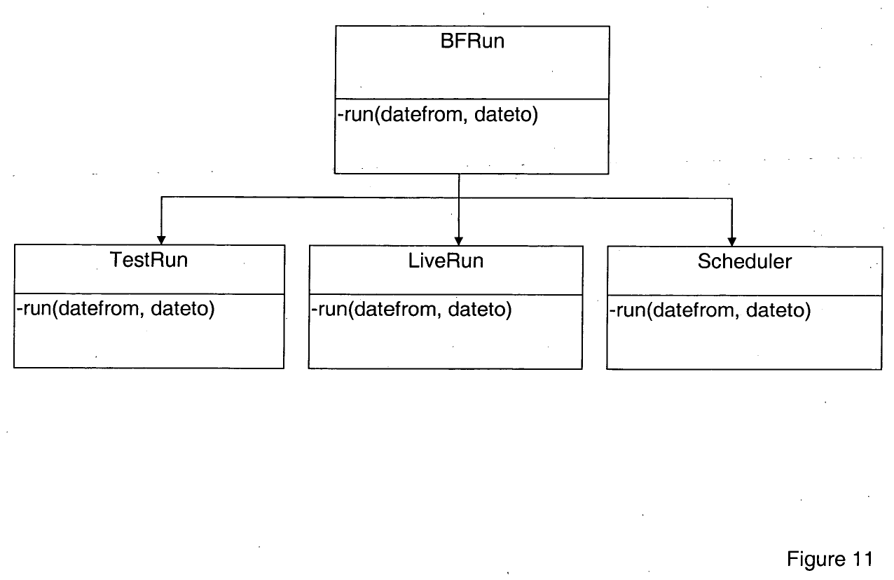

FIG. 11 shows the pattern that is used to execute a run for a business framework that is used in the system depicted in FIG. 6;

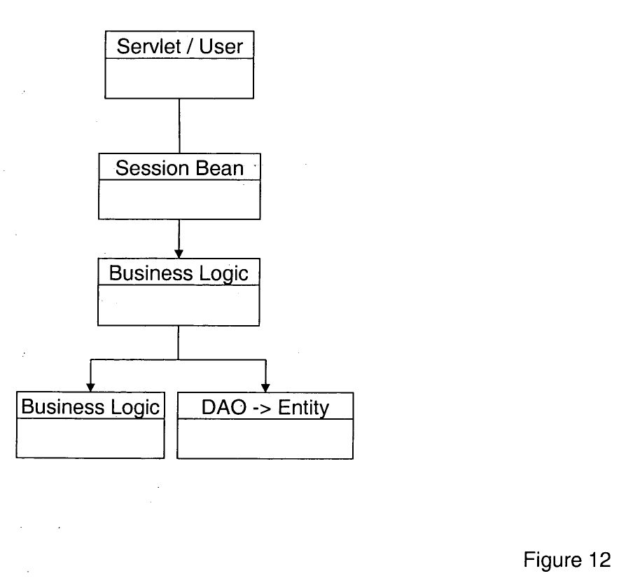

FIG. 12 shows a schematic depiction of the session facade with proxy pattern that is used in the system depicted in FIG. 6;

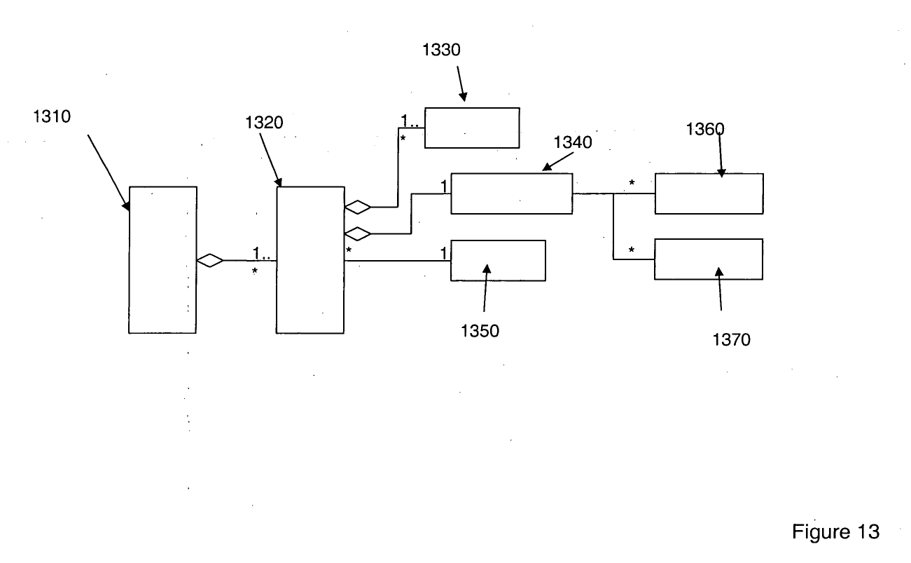

FIG. 13 shows a schematic depiction of the class diagram that describes how different objects interact that is used in the system depicted in FIG. 6;

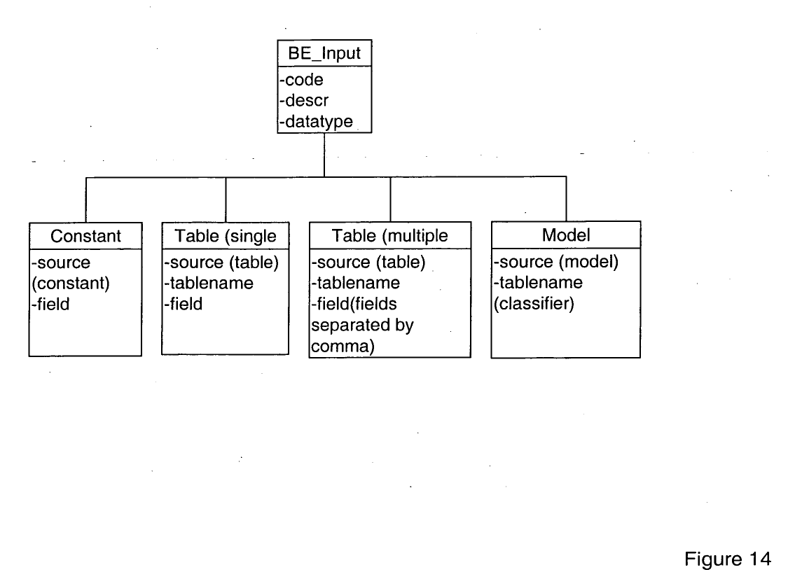

FIG. 14 shows a schematic depiction of the four different input types, along with the attributes that are associated with each input type, which are used in the system depicted in FIG. 6;

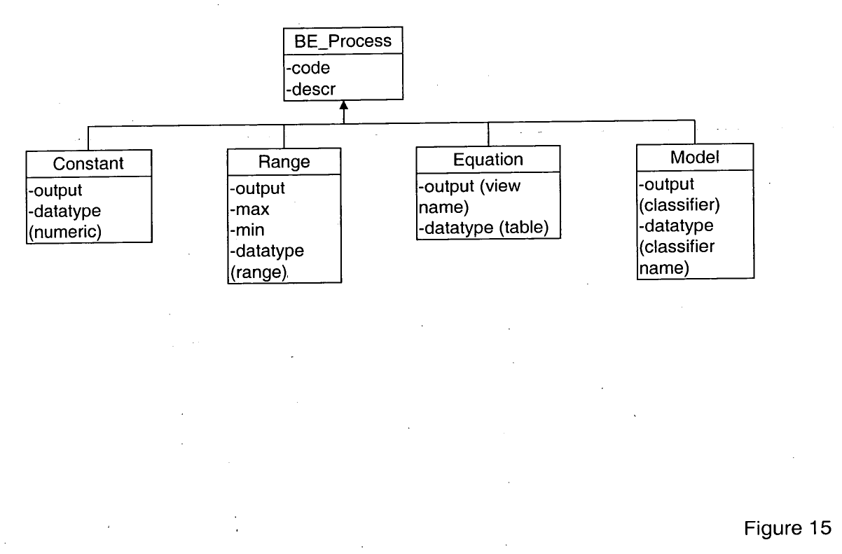

FIG. 15 shows a schematic depiction of the four different types of business entity process, along with the attributes that are associated with each process type, which are used in the system depicted in FIG. 6;

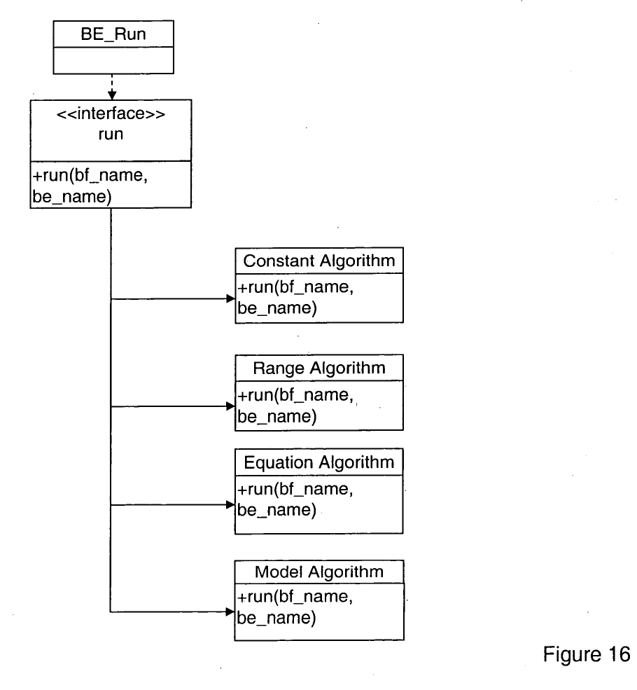

FIG. 16 shows the pattern for the execution of a business entity that is used in the system depicted in FIG. 6,

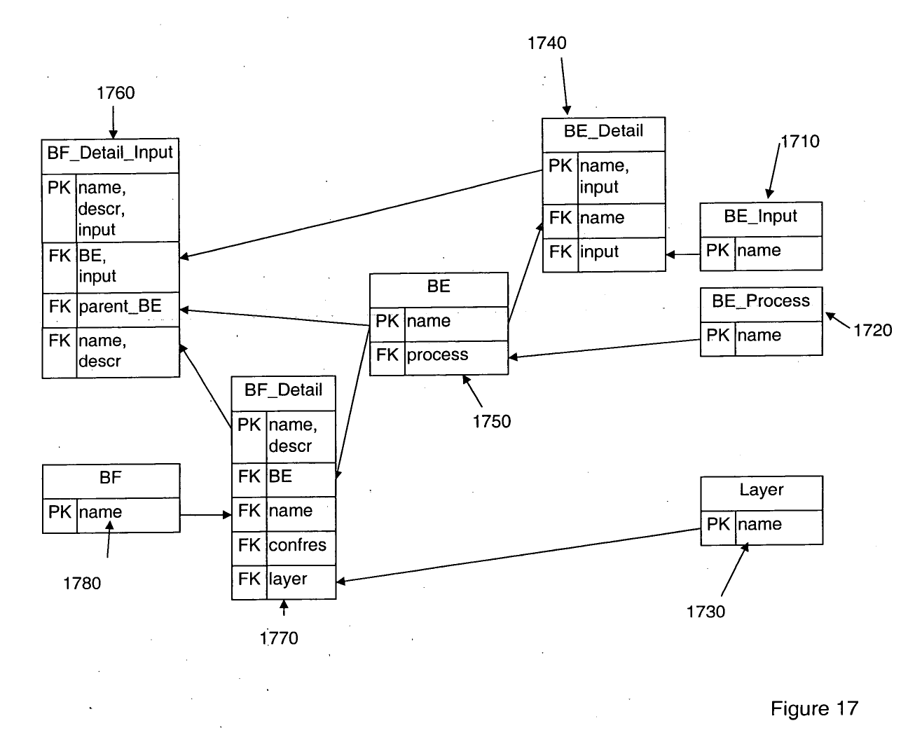

FIG. 17 shows the relationship of the data models used in the system that is depicted in FIG. 6;

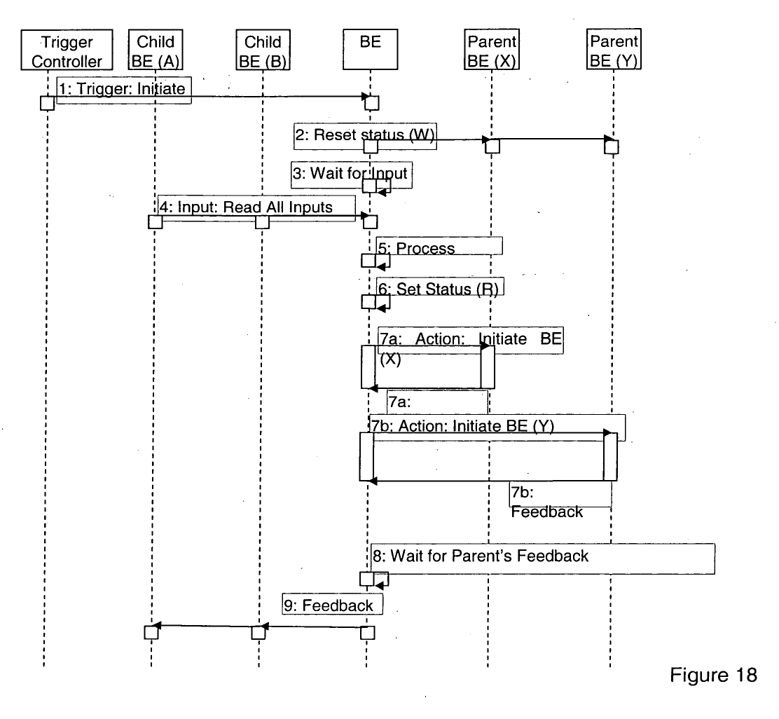

FIG. 18 shows a schematic depiction of the flow of information between business entities during the execution of a business framework which is used in the system depicted in FIG. 6; and

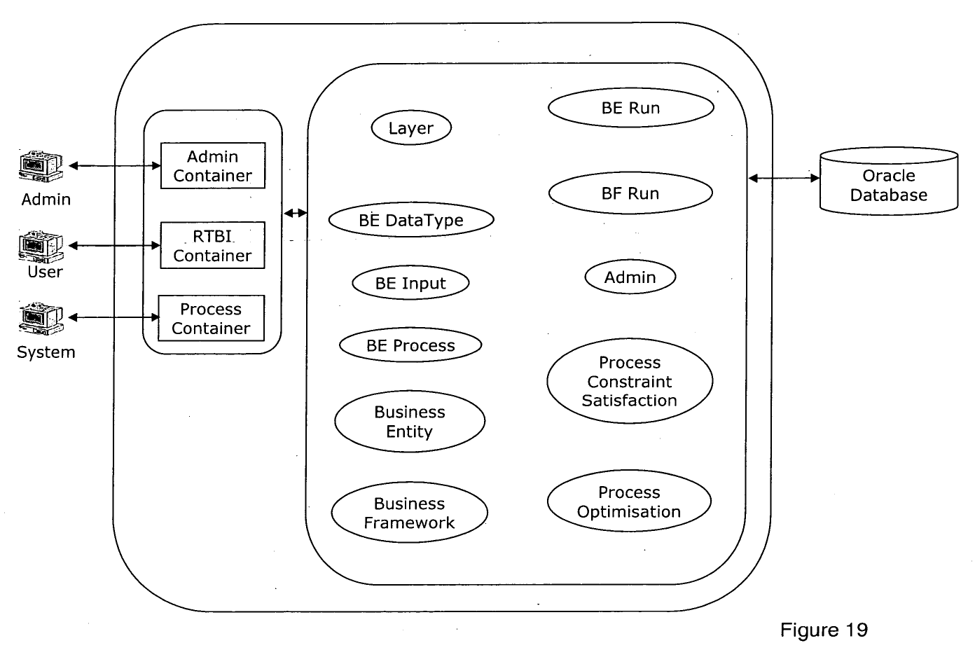

FIG. 19 shows a schematic depiction of the object models used in system that is described in the software specification described below in Annex A.

FIG. 1 shows a schematic depiction of a simplified arrangement of a system 5 according to the present invention in which the system 5 comprises one or more user terminals 10, a console utility 12, business logic unit 14, one or more databases 18a, 18b, 18c and one or more respective data interfaces 16a, 16b, 16c. In use, the a connection is made between a user terminal and the console utility such that the user terminal can access the data that is presented by the console utility. The console utility is connected to the business logic unit, which is in turn connected to the one or data interfaces 16a, 16b, 16c. The data interfaces 16a, 16b, 16c allow the data held in the respective databases 18a, 18b, 18c to be fed to the business logic unit 14. The databases 18a, 18b, 18c hold the data parameters that describe a number of different processes that are associated with one or more business activities.

In the field of business intelligence, the term business entities (BEs) is conventionally used to represent a value or a measure that indicates the performance or status or a process or an activity that is carried out or performed as a part or a component of a business operation. For example, a business' entity may represent the number of operatives who are on duty in a call centre or a measure of customer satisfaction. Business entities can be broken down into a number of categories, for example those business entities (such as the number of call centre operatives) that are entirely controlled by the business organisation, or external business entities (referred to as external levers) which represent factors that are outside the control of the business organisation (for example, weather conditions, the rate at which calls are made to a helpline, etc.). A number of these business entities can determine the value or state of tactical business entities (sometime referred to as key performance indicators (KPIs)) and also of strategic business entities (which can have targets that are sometimes referred to as strategic objectives (SOs)). The data that is held within the databases 18a, 18b, 18c is associated with a number of BEs.

The business logic unit comprises the various relationships that link the BEs associated with the data held in the databases 18a, 18b, 18c to the other external BEs and the tactical and strategic BEs that are associated with the business processes. Thus, as the business logic unit acquires data from the databases 18a, 18b, 18c, this data can be used to determine the values for the various BEs those processes and business activities. A user terminal that is connected to the console utility is able to determine whether the SOs are being met (i.e. if the value for a SO is above a predetermined threshold or within a predetermined range of values). As more data is collected in the databases, this is fed by the data interfaces to the business logic unit and the data displayed at the console utility can be updated accordingly.

A connected user terminal is also able to use the console utility to predict the response of strategic and/or tactical BEs to different parameter values in one or more processes. This allows the impact of different parameters (which may represent the outcome of different business decisions, such as investigating in new equipment or changing the staffing levels for a particular process) to be modelled and the outcomes predicted. Alternatively, a user may specify given values for one or more SOs in the console utility and the relationships held in the business logic unit can then be used to establish the values for the lower level BEs that would be required in order to provide the desired SO value(s).

FIG. 2 shows a flowchart that sets put the processes that are carried out by the system described above with reference to FIG. 1. Initially a performance framework is defined in step S210. Then at step S220 the business logic unit collects data from the various databases and data sources that it is connected to. The collected data and the performance framework are then used to determine the model(s) that describe the relationships that are defined within the performance framework at step S230. These models and the data can then be used to perform a number of different analytical processes; a ‘what-if analysis’ at step S240, target optimisation at step S250 or a prediction at step S260. The outputs of these steps are displayed within a user interface at step S270 (which may be viewed, for example, by one of the user terminals.

The data that is collected at step S220 may be displayed within a user interface at step S270 to allow the performance at that particular instance to be viewed. The outputs of the analytical processes (‘what-if analysis’ [step S240], target optimisation [step S250] or prediction [step S260]) can be fed back to the performance framework definition process (S210) in order to allow the performance framework to be altered or updated in the light of the results of the analytical process. Each of these processes will now be described in greater detail.

The main building blocks of a performance framework are Business Entities (BEs) that each represent exactly one performance quantity of a part of the organisation. Examples are strategic quantities like customer satisfaction or profit and tactical or operational quantities such as ‘average time to clear a fault’ or ‘number of abandoned calls in call centre’. Furthermore, it is necessary to distinguish between
a internal performance quantities (for example customer satisfaction, profit, customer churn rates, etc.)
external influences stemming from the business environment, i.e. anything related to customers, competitors or other factors like weather, which influence the business performance
business levers which can be changed in order to improve the performance, e.g. the number of call centre staff.

The first step of building a performance framework is to identify relevant performance quantities which can be represented by BEs. The search for appropriate performance quantities (and hence appropriate BEs) is usually driven by the strategy of the business. Typically, appropriate performance quantities can be identified using the following questions:
Which strategic goals can be expressed in terms of measurable quantities?
What are the influences of strategic quantities at tactical levels and which operational quantities influence tactical ones?
What can business levers can be controlled in order to influence business performance?
What are the external influences that have to be taken into account?

Once all the relevant quantities have been identified, it is then possible to produce a hierarchical influence-based framework that indicates the inter-relationships between the different business entities. Business levers and external influences are at the bottom of the hierarchy, linking into key performance indicators above them. These in turn are linked to tactical factors and finally to strategic objectives at the topmost level. It is possible to construct a framework chart in which directly related quantities are linked by an line. FIG. 3 shows an example of such a framework chart that describing a process that is carried out within a call centre. FIG. 3 has been divided into three different sections by the horizontal dashed lines. The lower section 330 comprises the parameters that can be directed controlled by the business organisation. The middle section 320 contains the KPIs that are influenced by the parameters that are represented in section 310. Section 330 contains the SOs that are influenced by the KPIs shown in section 320.

It can be seen from FIG. 3 that it should be possible to reduce the cost of the process by reducing the number of technicians and/or agents that are employed in the execution of the process. However, it seems intuitive to assume that a reduction in the number of technicians will lead to a reduction in the ‘Clear Time’ quantity which will then have a negative impact on ‘Customer Satisfaction’. Similarly, a reduction in the number of agents will lead to an increase in ‘Abandoned Calls’ which may also lead to a reduction in ‘Customer Satisfaction’. In addition to determining which quantities are to be measured, it is also necessary to determine how these quantities are to be measured. For example, for the quantity customer satisfaction, survey data could be used to compute the relative number of very happy customers. An alternative could be to measure something like the average happiness of customers. The decision depends on which measurement definition is more relevant for the strategy. If the proportion of very happy customers is measured then the distribution of customers who are not very happy will be ignored. By focusing on the average customer happiness then no account is taken of the variation of happiness amongst customers. Stage 210 will preferably comprise the following processes:

210.1: Define each of the business entities representing performance quantities. For each business entity it is necessary to:

(a) specify the data type (numeric, symbolic) and the value domain. For example, all values are numeric and have a value within a predetermined range. In such a case having customer satisfaction may have a value in the range of 0%-100%;

(b) define a data source like a data base link, table, column, etc. For each data source at least two columns are required, a value column and a date/time column (which gives a time/date stamp associated with each value);

(c) specify when/how often data is to be retrieved from the data source; and

(d) specify any administrative information associated with the business entity (for example like responsible manager for the entity.

210.2: Define links between business entities. For each business entity it is necessary to

(a) provide a link to the other business entities whose performance quantities are directly dependent, whereby the direction of the link points to the dependent entity. For example, the time a customer has to wait in the calling queue depends on the number of call centre agents and the number of customers calling in (call rate);

(b) specify the relation between its inputs and its own value as a function (arithmetic expression) or set a flag such that the relationship is learned from data (see below);

(c) learn the relationship between the business entities from historic data if the flag has been set for that entity relationship (see above) and if the historic data for all entities involved in a relation is available (see more detailed description below).

Step 210.3: For external influences that impact upon KPIs and SOs, if sufficient historic data is available then predictive models may be learnt. If target optimisation is to be performed (see below) the it will be necessary to define a cost function with performance quantities as parameters and to specify whether this cost function is to be minimised or maximised in order to find the best solution. For example, the goal of the optimisation might be to find the number of technicians and agents given a call rate such that customer satisfaction>80% and cost will be minimised. The cost function in this case are simply the operating costs given the staffing levels. It will be understood that this sort of optimisation problem is routine to someone skilled in the art.

Once the performance framework has been defined then it is necessary to collect data in order to be able to establish the relationship between the various business entities. Data is collected from operational systems or other internal or external data sources. Typically, the system directly accesses data bases or data warehouses, but intermediaries or interfaces may be provided between the system and the databases.

When the system is first used, there will need to be a supply of historical data that can be used to determine the relationships between the different business entities (see below). If such a data supply is not available then it will be necessary to provide some form of estimate or approximate evaluation of the relationship between the business entities. As data is collected it will be possible to re-evaluate or refine the relationships between the business entities.

The console utility can provide configurable dashboards to display the resulting performance figures (and optionally a relevant historical view) for each of the quantities within the framework. This approach is considerably different from common reporting where performance is only published on a regular basis (for example monthly, weekly or daily). The dashboards can also be set to provide alarms or traffic light type monitors such that warnings can be issued in case of a quantity exceeding a limit or threshold value. For each of the business entities a data retrieval schedule can be specified and when specified the most recent value of a measure with a time stamp is retrieved and stored. The visualisation of the performance measure can then be updated to include the latest data values.

Since data is being collected into the system on a regular basis for each performance measure, the performance values can be collected for each entity over time. In this way, a historical database can be built up for each measure which is essential for learning relationships between performance quantities.

When defining the performance framework those BEs that are believed to have a direct relationship are linked together. If this relationship is known then it can be expressed using an equation (or equations). However, many relationships are unknown in advance or are of a dynamic nature, i.e. they change over time as the business environment changes. An example of this is the relationship between operational quantities and customer satisfaction because customer satisfaction quite often also depends on external factors that might be difficult or impossible to be captured or measured.

As mentioned above, data is collected over time for each BE. Looking at linked BEs, it is then possible to form a connection between their historic data using time as the common link or key. Assume a relationship between the time to repair a fault and customer satisfaction, for example. The time to repair a fault is an operational measure that can potentially be re-evaluated whenever a new repair job has been completed. It is assumed that customers let the technicians know if they are happy with the time taken to make a repair. In that case it is possible to directly link the time taken with customer satisfaction. Standard regression, or more advanced machine learning, techniques can then be used to learn the relationship between time taken and customer satisfaction once this relationship has been learned then it is possible to predict customer satisfaction given a value for the time taken to make a repair.

It will be understood that it is important use data having a sufficient level of data quality to make sure that the relationships learned are sensible and relevant. However, it is conventional to perform data cleansing for reporting purposes, in order that the performance of the business organisation can be measured correctly. Additionally, the accuracy of relationship models can be tested, as is conventional with any learned model. If the accuracy of the relationship is too low, then it can be concluded that there is no significant relationship between the quantities in question and the link in the framework can be deleted. Some BEs might even be completely deleted as a consequence since there is no value in including performance quantities that do not contribute to the strategy of the organisation.

Other issues to be considered are the aggregation of data and different update frequencies of measurements. For reporting performance, data will quite often be aggregated over time, across geographical areas or over a certain group of customers. For learning relationships between data sets these different aggregations hide valuable relational information. If the time taken for jobs and customer satisfaction are each averaged over all customers in a week, the relation between the two measures expressed in each recorded pair (time taken, satisfaction) will be lost. Therefore, performance data should always be collected at lower levels than it might be visualised for monitoring purposes. Rather than representing relationships between aggregated performance values relationship models should therefore aggregate relationships between low level performance measures.

It is also necessary to consider the frequency of measurement. For example, customer satisfaction might only be measured on a weekly basis, but the time taken to complete a repair job may be measured hourly or even every 15 minutes. By joining the historic data of the two data sources on the variable time the amount of historic data is reduced to a single data record per week. In other words, historic data for relationships is used at the lowest of involved update frequencies. An exception can be made for the case where it is known that the low frequency measure is actually constant between two measurements taken. Additionally, it is necessary to make sure the data is consistent. For instance, if customer satisfaction is measured as an aggregated value over the period of a week, then time taken to repair must be a similarly aggregated value.

The type of relationship between two different business entities will depend upon the type of data (numeric, symbolic), the number of data records and other properties of the data (number of outliers, known mathematical properties of the relationship, etc.) and other managerial requirements (for example, that a model that be easily understood). Once an appropriate algorithm for learning the relationship from data has been chosen and configured, the historic data can be pre-processed accordingly and then the algorithm may be executed. It will be understood that the selection, application and execution of these algorithms are known to those skilled in the art of data mining. An automated approach to these process is disclosed in our co-pending international patent application WO2003/027899. By way of example, and without limitation, typically neural networks, neuro-fuzzy systems, fuzzy systems, regression trees, linear regression are appropriate relationship models for numeric relationships, decision trees and Bayes classifiers are typically appropriate for use with symbolic relationships and neural networks, autoregressive integrated moving averages (ARIMA) and Fourier transforms are typically used when modelling with time series data. It will be understood that other models and techniques may be used as appropriate.

The accuracy of a model should be checked on a regular basis by comparing the output of the model with actual data values which have not been used to learn the model (conventional accuracy measures, such as root mean squared (RMS) error for numeric relationships and classification accuracy for symbolic relationships, are well known to a skilled person). Our co-pending application WO2006/097676 discloses an automated approach for checking the suitability of a model and replacing it automatically if the suitability of the used model falls below a predetermined performance threshold.

The values associated with each business entity can then be displayed within the console. Many of the business entities will have their value supplied by a data feed and thus their value can be simply displayed. For those business entities (for example KPIs and SOs) that have a value that is derived from the values of other business entities then once those relationships have been determined then the values for those business entities can be displayed, via the console utility, to the user terminals so that the performance of the system under monitoring can be displayed. This enables the actual performance of a business or organisation at a given point in time. However, a system according to the present invention can be used for other aspects of performance management that can be used to improve the performance of the business. The use of a system according to the present invention to monitor in real time the performance of a business based on current parameter values is in part dependent upon the determination of the relationships between the various business entities. Once these relationships have been established then it is possible to use these relationships to derive parameter values given a desired level of business performance. A system executing a method according to the present invention can generate real time business intelligence in the sense that as the data representing process parameters is updated in the databases, then the effect of this updated data will propagate through the performance framework, leading to updated values for any strategic objectives.

As discussed above, some business entity values may be measured or provided on a relatively frequent basis (for example, clear time, number of technicians, wait time, etc.) whereas some more other business entity values, such as customer satisfaction, may be measured less frequently, for example weekly or monthly. Once a performance framework has been established and the various relationships within have been determined, then it will be possible to estimate the business entity values that are determined on a less frequent basis using the business entity values that are measured on a more frequent basis. This estimation may allow the those business entities whose value can be estimated to be measured at a further reduced frequency.

FIG. 4 shows a flowchart that describes the processes involved when a system according to the present invention is used to predict the performance of the business process(es) modelled by the performance model. This allows a range of values for external influences to be entered into the model, allowing corresponding values for KPIs and SOs to be generated. By performing these predictions it is possible to improve the understanding of the modelled business processes. It will be seen that there is some similarity between the prediction process described with reference to FIG. 4 and the what-if analysis described below, except that for the prediction process the values of the external influences are provided automatically rather than set manually.

At step S410 the model of relationships that was defined for the performance framework of interest is loaded and then a set of business lever values is entered (step S420). The values of external influences can be predicted and then automatically entered into the models (step S430) in order to derive the predicted values for the desired strategic objectives (step S440) which can then be displayed via a user interface. If it is desired to generate a range of predictions across a range of input values (for business lever values and/or or for external influence values) then the prediction process can loop back through and repeat steps S420 to S440 as required.

FIG. 5 shows a flowchart that describes the processes involved when a system according to the present invention is used to optimise the performance of a business system or process. Target optimisation is a process which enables strategic targets to be specified and then the system determines what values for the lower level business entities are required to achieve these strategic targets. As the relationships between business have been defined or learned in a ‘bottom-up’ manner then, in the general case, there is not a one-to-one relationships, that is their inverse relationship does not exist. In other words, given the value of a BE it is not possible to simply compute the values of its incoming BEs, but there may be several solutions, if any, to this problem. In order to pick the best solution it is necessary to specify an optimisation problem in which values are found for all business entities such that the strategic targets will be achieved, a cost function be minimised (or maximised) and other constraints (such as valid value ranges) be fulfilled. For example, such an optimisation problem could require that customer satisfaction exceed 90% and try to find a solution that maximises revenue (or alternatively minimises costs). The optimisation solution then provides target values for all business entities which, if adhered to, should provide the desired strategic targets.

Referring to FIG. 5, in step S510, the model of relationships that was defined for the performance framework of interest is loaded and then the target values are defined for the strategic targets that are of interest at step S520. Appropriate optimisation procedures (see below) are then executed at stage S540 in order to provide a solution that gives the required target values along with any other constraints or limits. If such an optimised solution can be identified then it can be displayed via the user interface at stage S550. If a suitably optimised solution can not be found then it is necessary to review some of the variables and parameters at step S540 and then repeat stages S530 & S540.

Suitable optimisation procedures are known to those skilled in the art but may be, for example, heuristic search strategies, such as hill climbing solutions, simulated annealing, evolutionary strategies, etc. These provide the best value configuration in the performance framework such that

(a) the business entity values are in the specified value domain

(b) the business entity values are in accordance with the relationships

(c) the target values of the strategic business entities are reached

(d) the cost function for optimisation is minimised (or maximised as appropriate)

A further analytical procedure that may be performed using the method of the present invention is a ‘what-if’ scenario. By performing a ‘what-if’ scenario it is possible to improve an understanding of one or more business processes by varying the values of one or more business levers and external influences and analysing the impact on the performance of the process(es). By using what-if analysis it is possible to model the future performance of the business such that it is possible to develop the business in a more proactive manner as internal and external business influences change. A what-if analysis involves the steps of:

1. Loading the appropriate performance framework definitions;

2. setting values for the business levers and external influences

3. propagating business entity values through the performance framework using the inter-business entity relationships, such that

(a) business levers and external influences send their values to their successors in the business framework

(b) as soon as a successor has received the values from all its inputs, it computes its own value by evaluating the relationship model

(c) any node that has computed its value passes it upwards in the framework until all values have been computed; and

4. Displaying the results via the user interface.

A specific embodiment of a further system according to the present invention will now be described with reference to FIG. 6. FIG. 6 shows a schematic depiction of the interrelated software layers that define the operation of the system. The system 600 comprises a presentation layer 610, control layer 670, business logic layer 660, data access object layer 650, resource layer 640, value object layer 630 and architectural utility layer 620. The presentation layer 610 comprises one or more client applications and/or applets, the control layer 670 comprises one or more servlets 672 and one or more session beans 674; the business logic layer comprises one or more Enterprise Java Beans (EJBs) 662 and one or more Java classes 664; the data access layer comprises one or more data access objects 652 and one or more entity beans 654; the resource layer comprises one or more Oracle databases 642, one or more operational support systems 644 (OSSs) and one or more Siebel customer relationship management (CRM systems 646. It will be readily apparent to the person skilled in the art that the system 600 can be implemented using Java. Java was used as it was readily available to the inventors and because of its well known advantages. Oracle databases and Siebel CRM systems were also used because they were available to the inventors. The use of these products is not necessary for the implementation of the present invention and it will be understood that they could be replaced by products that provide similar or equivalent functionality.

The software layers are structured such that a request made at the presentation layer 610 must be passed through to resource layer 640 via the control layer 670, the business logic layer 660 and the data access layer 650. Each of the presentation layer 610, the control layer 670, the business logic layer 660 and the data access layer 650 are able to access the value object layer 630 and the architectural utility layer 620 as required.

The presentation layer 610 may use one or more rich-client application(s) to control display to the end user. Alternatively, it may be extended to provide an applet for use in conjunction with a web browser. The control layer 670 receives all incoming requests from user terminals, redirects the requests to its respective business logic object, and sends outgoing responses back to the appropriate user terminal. The business logic layer 660 manages real-time business intelligence processing rules and logic. The data access layer 650 manages reading, writing, updating, and deleting stored data. The value objects layer 630 comprises structures for related business information that are transferred between a user terminal and a server. The architectural utility layer 620 contains generic application utilities that are commonly used throughout all layers of the system.

FIG. 7 shows a schematic depiction of the system 600 described above with reference to FIG. 6: FIG. 7 shows a schematic depiction of the architecture of the system 600 and the different horizontal software layers of FIG. 6 are shown in FIG. 7 as vertically separated regions of the architectural depiction of the system. User terminals 705 make connections to a connection servlet 612 (which is within the presentation layer 612) which are then passed on to a servlet 672 in the control layer 670. The control layer preferably comprises a number of different types of servlets, for example a login servlet 672a that controls access to the system, such that unauthorised users can not gain access to the data held within the system, or other servlets 672b, 672c which may, for example, allow a user to access the business intelligence being generated by the system, to manage the system, to configure the system to generate business intelligence for a new process, etc. All of the servlets 672 are in communication with a session facade pattern 674 which manages communications between the servlets 672 and the other layers of the system. The session facade pattern 674 is in communication with the business logic unit 740, which is in the business layer 660. The business logic unit 740 is in turn in communication with a plurality of data access objects (DAOs) 652 in the data access layer 650; preferably the business logic unit comprises a plurality of business objects. Different DAOs are required for the different types of data resource that are present in the resource layer 640. For example, FIG. 7 shows that a database DAO 652a accesses an Oracle database 642a via entity bean 752 and a second database 642b via a hibernate object. A Siebel DAO 652b provides access to a Siebel CRM system, via Java EE Connector Architecture (JCA) object 756 and an OSS DAO 652c provides access to data held in one or more OSS via XML translator 758. The user terminals may be a bespoke dedicated terminal or a computer program executed within a personal computer or similar device. In an embodiment of the present invention, the user terminal may be able to access the system using a conventional web browser.

The different components and layers of the system will now be described in greater detail. The data access layer 650 manages access to and persistent storage of business information. The DAOs use different ways of storing the data that are hidden from the business layer. FIG. 8 shows a data access pattern that is used by the system. Entity Beans with container-managed persistence (CMP), Hibernate or XML objects are used in order to persist different kinds of data. Business layer object 742 is in communication with value objects (see below) that represent business entity values 744 or business frameworks 746 (for the sake of clarity only one of each type of value objects is shown: it will be understood that the business layer object 742 may be in communication with more than one of each type of value objects. The business layer object 742 is also in communication with a plurality of DAOs 752, 754, 758. DAO 752 is a business entity DAO that controls access to an Oracle database table 642a DAO 752 may be implemented using Enterprise Java Beans with container managed persistence or Java Database Connectivity (JDBC). Business framework DAO 754 controls access to an object database datastore 642b and may be implemented using Hibernate to mapping an object-oriented domain model to a traditional relational database (see www.hibernate.org). DAO 758 is an XML DAO that allows data held in an XML document 644, for example data extracted from an OSS, to be accessed.

Value objects contain business information that is transferred within the system. A value object can be used as a means of communication across all layers of the application. Each value object contains only information pertaining to the characteristics of the value object and common procedures are provided in order to enable the retrieval and updating of information. FIG. 9 shows a typical value object pattern 900, which includes procedures to get each attribute, set each attribute, and to convert the value object to a string.

The business layer 660 contains business layer objects that combine data with real-time business intelligence rules, constraints, and activities. The business layer defines all business logic that is embedded in each business layer object, for example, the execution of each step of a business entity, the controlling for execution sequence of a business framework, computing the value for scorecard and dashboard, etc. FIG. 10 shows the pattern 1000 for a business object, which can either be a business entity object or a business framework object. FIG. 11 shows the pattern that is used to execute a run for a business framework.

The session facade pattern 674 is used to coordinate operations between cooperating business objects, unifying application functions into a single, simplified interface for presentation to the calling code. It encapsulates and hides the complexity of classes that must cooperate in specific, possibly complex ways, and isolates its callers from business object implementation changes. It manages the business objects, and provides a uniform coarse-grained service access layer to clients. It is the place where all calls to entity beans are made FIG. 12 shows a schematic depiction of the session facade with proxy pattern.

The presentation layer 610 comprises all the graphical user interfaces that an end user physically sees. Preferably, a client centralized controller for managing requests is provided. It forwards each request of the client to a servlet and receives the incoming responses, and presents an appropriate response to the client. It also acts as a point to display any error occurred in the server to the user.

All layers together form the PAC pattern, which is the distributed version of the MVC pattern. The PAC pattern separates the client view from the business logic and manages the communication between them. The PAC pattern comprises a Presentation, Abstraction and Control layers. The Presentation Layer resembles the View and Controller of the MVC pattern. The client (V) shows a graphical representation of the data to the user and sends requests to the server (C). The Abstraction Layer resembles the Model (M) and consists of the Business and Data Access Layer. This is where the actual work of the system is done. The Control Layer acts as a gateway between Presentation and Abstraction and typically it is implemented using the Facade pattern.

Table 1 below shows a list of the object models that are generated after analysis of the cases.

TABLE 1
Corresponding mapping of use cases and object models

| Use Case | Objects |
|---|---|
| BF Designer | BFDesigner |
| Manager | Manager |
| liveBF | BFLive |
| BE Input | BE_Input |
| BE Process | BE_Process |
| Business Object | BE |
| Business Model | BF |
| Data type | BE_DataType |
| Actual Value | ActualValue |
| Target Value | TargetValue |
| Dashboard | Dashboard |
| BE fixed value | BE_FixedValue |
| BE range value | BE_RangeValue |

FIG. 13 shows a schematic depiction of the class diagram that describes how different objects interact. The figure shows that business framework values 1310 are generated based on business entity values 1320, which are in turn dependent upon business entity input values 1330, the business entity process 1340 and the layer 1350. The BE_input object 1330 may be one of four different types of input: constant, table with a single field, table with multiple fields, and model. FIG. 14 shows a schematic depiction of the four different input types, along with the attributes that are associated with each input type. There are four different types of business entity process 1340 (BE_Process): constant, range, equation and model. The values of each attribute are represented based on the type of process. FIG. 15 shows a schematic depiction of the four different types of business entity process, along with the attributes that are associated with each process type. FIG. 16 shows the pattern for the execution of a business entity. There are four different types of process that can be executed in a BE: constant, range, equation, and model. Each type has unique algorithms to generate the output for a BE.

FIG. 17 shows the relationship of the data models used in the system. There are three main master tables namely: BE_Input 1710, BE_Process 1720 and Layer 1730. BE_Input 1710 contains definition about the input that a business entity can take. BE_Process 1720 defines the process that a BE 1750 will perform and generate an output for the BE 1750. Layer 1730 contains information denoting the layer that a BE 1750 sits, for example, strategic, tactical and operational.

FIG. 18 shows a schematic depiction of the flow of information between business entities during the execution of a business framework. A trigger can either be initiated manually from an application graphical user interface (GUI) or by the system initiated from another BE or a timer-controlled component. The BF controller receives the trigger and sets the information flow in the network.

An input is a collection of data that will be used by a BE to perform one or more processes. This may be restricted to input having a numerical or timescale data type, which can hold a fixed value. Alternatively, the system may be able to deal with inputs that have a range of values, such that the system would have to implement performance optimisation, which includes an algorithm to find an optimal set of values that satisfy the specified target. Furthermore, an input may be able to take on more complex forms, for example a model such as a decision tree that has been generated by a parent node in the business framework. Other complex models that could be used in such a manner include, without limitation, regression trees, neural nets, Bayesian nets, or any machine learning algorithm.

A BE can have multiple inputs that have different effects. A BE can also accept multiple tables as input. In which case, the system will automatically map their join relationship as defined in the database. In cases where there are no relationship found, then the system will extract the data based on the Cartesian Product of these tables. All singleton variables will also be outer joined with these tables.

A BE process is performed using the information collected from all its inputs. If there are multiple inputs, then the BE would wait for all the inputs to arrive before performing any execution. The BE process can include mathematical equations that are entered using the system formula editor, table mapping from a table in the database, or model generation as defined in the classifier configuration. The output of the process will be used as an input to other children BEs.

After the BE has processed the information, it will return control to the BF controller, indicating whether the process has been successfully executed. This indicates to the controller that the input, which may be connected to one of more parent BEs, is now ready for despatch. The controller then activates a BE when all children inputs connecting to it are ready. The final task of a BE would be to return a feedback to the BF controller, indicating whether it is able to meet the target set for it.

Annex A below sets out a software specification for the implementation of a system according to the present invention. It will be understood that this specification is provided only as an example of how a system according to the present invention might be implemented and that it should not be used to interpret the scope of the present invention.

### ANNEX A

FIG. 19 shows a schematic depiction of the object models used in system that is described in the software specification below.

### A.1 Definition of Layer

### Function

This GUI allows the user to define layer for a business framework. Fields include:
name
Description
   The table below is an example of different layers in the system.

| Name | Description |
|---|---|
| S | Strategic |
| T | Tactical |
| O | Operational |
| W | Working |

### Bean Type: Container-managed Bean

### Table Name: Layer

### Table Specification

| Key | Field | Description | Type | Size |
|---|---|---|---|---|
| PK | Name | Name of | VARCHAR2 | 30 |
| | | Layer | | |
| | Descr | Description | VARCHAR2 | 50 |

### A.2 Definition of BE Input

A BE Input defines the data that a BE used to perform some process like data analysis or breaking down of target into small units for its children BEs. The simplest form of an input would be a constant numeric value, for example a strategic target value set by the management. An input can also reference a field in a table. It can also be a table or view with some or all its fields. A complex form of an input would be a generated model like decision rules, which is defined using xml syntax.

A static parameter used in a business model is usually defined as a constant in BE input. If a parameter needs manual adjustment or constant monitoring of its value by a user, then it should be defined as a BE Process holding a constant value.

### Function

This GUI allows the user to define input for a business entity. Fields include:
Name
Description
Source—Tables, Constant, Model, BE
Field—Values, Classifier
Data Type—Numeric, Nominal, XML

| | Table | | Data Type |
|---|---|---|---|
| Source | name | Field | (XML) |
| Table | Table name | Fields separated by comma | Multiple |
| | | or * to indicate all fields | |
| Constant | | Value | Numeric |
| Model | | Classifier | XML |

### Bean Type: Container-managed Bean

### Table Name: BE_INPUT

### Table Specification

| Key | Field | Description | Type | Size |
|---|---|---|---|---|
| PK | Name | Name of BE Input | VARCHAR2 | 30 |
| | Descr | Description | VARCHAR2 | 50 |
| | Source | Source of input | VARCHAR2 | 10 |
| | Tablename | Tablename when source is | VARCHAR2 | 30 |
| | | table | | |
| | Field | Field associated with source | VARCHAR2 | 2000 |
| | DataType | Data type of field | VARCHAR2 | 50 |

### A.3 Definition of BE Process

A BE Process defines a method of processing input data and produce a model either for further processing or as an end-result. A simplest form of model could be a numeric value, for example a calculated target value and a complex form could be a decision tree, regression tree or a mathematical equation.

A user has the option of whether to define parameters used in a business logic either as a BE input or process. When the parameter is static and its value does not change throughout a business computational cycle, then it should be defined as a BE input. However, when the value of a parameter can be changed either automatically by the BF live cycle or manually through the interactive interface, then the parameter should be defined as a BE Process.

### Function

This GUI allows the user to define process for a business entity. Fields include:
Name
Description
Type
Constant
Range of values (min, max)
Mathematical equation (rtbi_formula)
Model Generator (classifiers)
Source
Value
Value_datatype: Numeric, Range, Table, Model, Update

| Type | Source | Output_datatype | Output |
|---|---|---|---|
| Constant | | Numeric | Numerical value |
| Range | | A range of numerical | Min (value), |
| | | values. Min and max values | Max (value) |
| Equation | Rtbi-formula | Table | View name |
| | (descr) | | |
| Model | Classifiers | Model | Classifier |
| Update | BE | | Numerical value |

### Bean Type: Container-managed Bean

### Table Name: BE_PROCESS

### Table Specification

| Key | Field | Description | Type | Size |
|---|---|---|---|---|
| PK | Name | Name of process | VARCHAR2 | 30 |
| | Descr | Description | VARCHAR2 | 50 |
| | Type | Type of process | VARCHAR2 | 10 |
| | Source | Source | VARCHAR2 | 30 |
| | Value_datatype | Value data type | VARCHAR2 | 10 |
| | Value | Value object | VARCHAR2 | 30 |
| | Min | Minimum value of range | NUMBER | |
| | Max | Maximum value of range | NUMBER | |

The definition of an equation in the BE_Process may have to be deferred until after the creation of the BF since the view will only exist after the inputs are defined for that BE. The output of the model may be constrained, for example, to a numerical value, a range of numerical values or a further model.

### A.4 Definition of Business Entity (BE)

A BE defines a basic business activity of an organisation. It can be used to represent strategies, plans, targets, goals, costs, budgets from the highest management level of an organisation down to the operational level that represents actual activities with measurable values.

### Function

This GUI allows the user to define all the components that are attached to a business entity. Fields include:
Name
Description
Contact EIN
BE Input
BE Process
Actual Value Manual Update
Notes

### Features Include:

A wizard to define the properties of a BE, which steps through input, process, formula editing, and model definition

### Validation:

If BE_Process is a constant, then it should only have one or no input.

### Bean Type: Container-managed Bean

### Table Name: BE

### Table Specification

| Key | Field | Description | Type | Size |
|---|---|---|---|---|
| PK | Name | Name of BE | VARCHAR2 | 30 |
| | Descr | Description | VARCHAR2 | 50 |
| | Contact_EIN | Contact person for | VARCHAR2 | 12 |
| | | delivering the goal | | |
| | | of BE | | |
| FK | Process | Name of BE_Process | VARCHAR2 | 30 |
| | Act_Manual_Upd | True for manual | VARCHAR2 | 5 |
| | | update, false | | |
| | | otherwise | | |
| | Notes | Additional Notes | VARCHAR2 | 200 |

### Table Name: BE_DETAIL

### Table Specification

| Key | Field | Description | Type | Size |
|---|---|---|---|---|
| PK | Name | Name of BE | VARCHAR2 | 30 |
| PK, FK | Input | Name of | VARCHAR2 | 30 |
| | | BE_Input | | |

When a BE is created, a corresponding BE_input is also created with the following setting:

| BE_Input | BE Fields |
|---|---|
| Name | Name |
| Description | Description |
| Source | “BE” |
| Data type | BE_Process data |
| | type |

### A.5 Business Framework (BF)

A Business Framework (BF) allows a user to formulate their business plan and visibly link their strategic goals to operational targets. It provides an overall picture on the structure on how management goals are propagated down the operational level to fulfil. It also displays the relationship between BEs in a BF. When the BF is used in a simulated or test run with historical data, a user can validate the feasibility of targets set in all levels of an organisation.

### Function

This GUI allows the user to formulate the business framework for an organisation by constructing a graph containing business entities, each representing a business object or activity, and linking them together showing the relationship between these entities. It provides an interactive and friendly environment with easy-to-use toolkit to construct the chart. Fields include:
Name
Description
Contact person
Additional notes
   Features include:
Ability to add, amend and delete a BE or predefined BF
Create directional relationship between two BEs
linking the output of a child BE to an input of a parent BE on the condition that both have the same data types
If the BE is an embedded BF, then
a parent BE can be linked to one of the root nodes of a BF
a child BE can be linked to one of the leaf nodes of a BF
a leaf node does not need to be connected
Define conflict resolution when some process fails
Create/Edit a legend to colour-code different layer types of BE (e.g. green for S, blue for T, gold for 0)
Provide an alias to each BE (default: BE Name)
Status to indicate whether the BE is ready to execute
Status to indicate whether the BF is ready to execute if it is used as a BE
Validate: highlight invalid entities with red border line

### Validation:

When creating relationship between two BEs, check that the output of child BE process has the same data type as parent BE input.
All inputs of a BE are connected

The following table shows the relationship between links of a parent and child BE. There are four different variants of input available for a BE and each has a data type. There are also three variants of output available: numeric, table and model.

| Input | Output |
|---|---|
| Table - single attribute | Table |
| Table - multiple | Table |
| attribute | |
| Constant - Numeric | Numeric |
| Model | Model |

### Bean Type: Container-managed Bean

### Table Name: BF

### Table Specification

| Key | Field | Description | Type | Size |
|---|---|---|---|---|
| PK | Name | Name of business framework | VARCHAR2 | 30 |
| | Descr | Description | VARCHAR2 | 50 |
| | Contact_EIN | Contact person for maintaining this | VARCHAR2 | 12 |
| | | framework | | |
| | TrainData | Table name of data to generate the model | VARCHAR2 | 50 |
| | RealTimeData | Table name of data to measure real-time | VARCHAR2 | 50 |
| | | model | | |
| | Status | Wait (W), Ready (R) | VARCHAR2 | 1 |
| | Valid | True when all links are valid, false otherwise | VARCHAR2 | 5 |
| | Notes | Additional Notes | VARCHAR2 | 200 |
| | Show_Level | Number above and equal to this level will be | NUMBER | |
| | | shown | | |

### Table Name: BF_Detail

### Table Specification

| Key | Field | Description | Type | Size |
|---|---|---|---|---|
| PK, FK | Name | Name of business | VARCHAR2 | 30 |
| | | framework | | |
| PK | BE_Name | Alias of BE | VARCHAR2 | 50 |
| FK | BE | Name of BE | VARCHAR2 | 30 |
| FK | ConfRes | Name of Conflict | VARCHAR2 | 30 |
| | | Resolution | | |
| FK | Layer | Name of Layer | VARCHAR2 | 1 |
| | Status | Wait (W), Ready (R) | VARCHAR2 | 1 |
| | LevelNo | Level to be displayed in | NUMBER | |
| | | GUI | | |
| | Target | Target Value of a BE | NUMBER | |
| | Actual | Actual Value of a BE | NUMBER | |
| | Model | Modelled Value of a BE | NUMBER | |
| | Predicted | Predicted Value of a BE | NUMBER | |

### Table Name: BF_Detail_Input

| Key | Field | Description | Type | Size |
|---|---|---|---|---|
| PK, FK | Name | Name of business | VARCHAR2 | 30 |
| | | framework | | |
| PK, FK | BE_Name | Alias of BE | VARCHAR2 | 50 |
| PK, FK | Input | Name of BeInput | VARCHAR2 | 30 |
| FK | BE | Name of BE | VARCHAR2 | 30 |
| FK | Child_BE | Name of Child BE | VARCHAR2 | 30 |

### Table Name: BF_Graph

| Key | Field | Description | Type | Size |
|---|---|---|---|---|
| PK | Name | Name of business framework | VARCHAR2 | 30 |
| | Valid | True for valid BF, false | VARCHAR2 | 5 |
| | | otherwise | | |
| | Graph | Graph of business framework | CLOB | 50 |

### A.6 Simulated Timer Control Panel

This panel controls the timer for a business framework simulation. Once the timer is started, the time indicated in this panel will be used to synchronise the date and timestamp used in all simulators, dashboard and scorecard.

### Function

This GUI will synchronise the timestamp for the entire application. Any time dependent programs, like simulator, dashboard and scorecard, will retrieve the current simulated time from this panel. Fields and selections include:
Current simulated time
Start, stop, pause, resume button (toggle between start and stop, pause and resume)
Table: table that contain the date field
Date Field: A list of date fields from the selected table
Date Selection: A list of dates from the date field selected
Time Selection: hour and minutes selection
Speed Factor: Time multiplier to speed up or down the simulated time: x indicates x times faster
Update Interval: The interval to update the simulated objects

### Issues

### A.7 Performance Management Dashboard

This dashboard gives a snap-shot display on the performance of some business entities using a performance chart. Each BE in the chart is displayed using traffic light colours (green, orange, and red) to show the performance against their respective targets. This allows the user to monitor the overall performance of the organisation and quickly identify hot-spots. The timestamp of the dashboard is taken from the simulated timer control panel as described in Section 0.

### Function

This GUI allows the user to have a snap-shot on the performance of some BEs of the organisation. Selections include:
Name of BF
Alias of BE
   Features include:
Drill-down for more details

### A.8 Performance Management Scorecard

Scorecard shows conventional information about performance of an activity with respect to the target being set for a BE. Each BE displays a trend, either up or down, against the target. This GUI displays scorecard using a chart. It helps to communicate clearly strategic goals across the organisation. It also illustrates cause-and-effect relationships between business entities. The timestamp of the scorecard is taken from the simulated timer control panel as described in Section 0.

### Function

This GUI allows the user to have a snap-shot on the performance of a particular BE. Selections include:
Name of BF
BE that holds the target value
BE that holds the actual value
BE that holds the model value
Type of display
   Features include:
Scorecard for each BE
Display information on each BE (actual values, target values, percentages, trends, etc)
Drill-down for more details

### A.9 Execution of BE

This function walks through all the steps that a BE executes from the moment it is being triggered through to return a feedback to the parent BE.

| Input | Output |
|---|---|
| Table - single attribute | Numeric |
| Table - multiple | No Match |
| attribute | |
| Constant - Numeric | Numeric |
| Model | Model |

### Function

A BE will execute the steps based on the process type as follows:
Process Type=constant
It should either have no or one input to this BE
If there is an input to this BE, then output of BE process will take on a new constant value from input
Return output as Object

### Process Type=Equation

Create a view using all BE_Inputs as sub-query and include formula as a variable in the main query
For sub-query, use inner joins if the relationship, which is defined by foreign keys, exists in the database, otherwise use Cartesian product
When the input has only one variable, it is aliased using input name
eg. for a constant: SELECT 50 AS beinput_name1.
eg. for a table with a single variable: SELECT table.abc AS beinput_name2
e.g. for a table with multiple variables: SELECT table.a1, table.a2, . . .
View name: BFName_BEName

### A.10 Execution of BF

There are four different types of execution of BF: Target setting, monitoring of model values, generating predictive models, and an action engine. Suppose the current time of the system is 2.30 pm and a period is set to one hour and the update period is on the hour, then the current period would be 2 to 3 pm and the next period 3 to 4 pm.
Target setting involves getting strategic targets set by some managers and the propagation of targets to lower level is performed using an optimisation process. The target setting must take external inputs (like number of requests) into account and adjusts targets for lower level BEs accordingly. In order to find target values for future/predicted scenarios it will be necessary to use the predicted values for external inputs. There are 2 different levels of target setting: A simple one that only tries to adjust targets inside their predefined range (e.g. increase number of servers) and a complex one that re-calculates all targets in order to meet a given high level target.
Model values are calculated using the current set of time-series data, i.e. 2 to 3 pm, and these values reflect the performance of the business model using the configuration that the system is currently using. These results are being closely monitored by users.
Predictive models can be generated using a pre-defined period of time-series data, for example the past one month data, to predict the business model for the next period, i.e. 3 to 4 pm. The system would need to first period the external factors like the number of requests and this value is fed into the business framework and the system proactively set the values in the leaves, e.g. number of servers and bandwidth, via the optimisation procedure using the target values.
The action engine uses the predicted model to update the operational BEs at some regular interval so that the business framework is changing real-time to handle the projected business environment. This means triggering the update procedure by setting the values in the model values using the predicted values on a regular interval, e.g. at 3 pm, and the configuration of the server farm is also changed in operation.
   In all cases, the execution of BF works in a similar fashion: It runs through one cycle of BF from leaf to root BE. A leaf BE is defined as one that does not have any child BE and a root BE as one that does not have any parent BE. Generally a root BE defines a rather abstract target (like customer satisfaction) and leaf BEs represent physical targets/values (like number of servers). When a BF is drawn the root BEs are on the top level while leaf BEs are at the bottom.

### Calculating Model Values

### Method Outline:

### 1. Load the BF

2. Traverse the graph from leaf to root BE
3. Execute each BE when all of its children have finished execution
4. Update model value of each BE with the result from execution

### Setting Target Values

### Target Setting Should be Triggered Whenever

A target is changed manually
Predicted values don't meet the target values

### Method Outline:

### 1. Load BF

2. Traverse the graph from root to leaf BE
3. Get desired input values from each BE when all of its parents have been updated before
4. Set value as target for child
5. If BE has multiple parents (and therefore receives multiple values for target value): perform conflict resolution

### Generating Predictive Models

### Predictive Model Should be Regenerated Whenever

A target is changed manually
Predicted values of external inputs, like number of requests, have changed

### Method Outline:

### 1. Load BF

2. Get a list of leaf BEs
3. Traverse the graph from leaf to root BE
4. At each BE:
Wait for all child BEs to be ready
Read in all inputs
Execute process as described in Section 0
if BE does not meet its target value, return fail else return results
   5. If a BE fails, request the child BE to recompute values

### Model Rebuild

The process/model of a BE needs to be rebuilt if its actual value doesn't match the predicted value, even though the children meet their targets. The re-learning should be done from historic data. If it is a formula probably user intervention is needed.

### A.11 BF Simulator

This simulator allows the user to run the BF with a specified set of time-series data. It can run with historical or live data that is collected in a database. It uses the same algorithms for both sets of data. During the simulation, the user can interact with the BF to display individual dashboard or scorecard. The simulator is activated together with the control panel, which supply the current simulated time. Parameter selection included in this simulator includes:
A table that contains the time-series data
Type of simulation: target, current, predict
Update interval and period
Start button to start the simulation, toggle the text to stop
Pause button to pause the simulation, toggle the text to pause

### Features

The Simulator has the following features:
Change the colour of the Legend
Set the level number. Each BE is assigned a level no. during the creation of the framework. The simulator will display BE with level no lower than or equal to the specified level.
Popup a window to set the target/actual value for a BE
Popup a dashboard for a BE
Popup a scorecard for a BE
   The simulator will execute the steps in the following order:
Send a request to the server to run the BF at a regular interval based on the selection in the control panel
Information including current simulated timestamp will be send to the server
Constantly monitor the status of the execution
Update the displayed information, e.g. scorecard, dashboard
   There are three types of simulation available in this option: target, current and predict.

### Target Value Simulation

This option allows the user to set the target values of some BEs. The user can then set up the simulation to test run the effectiveness of the new target values using historical data. Selections include:
Table containing the time-series data
Date field
Period of date
   When the simulation starts, it will find the best set of values for all leaf BEs that satisfy the constraints set in the root BEs using an optimisation procedure.

### Current Model Value Computation

This feature extracts data for the current period and calculates the model value for each BE for the entire business framework. This is a straight-forward value calculation that uses the current setting of the leaf BEs and traverse up the framework to calculate the root BEs. The comparison of target and model value can be viewed using a scorecard so that the user can monitor the performance of its business model. Alternatively, the user can select specific BEs to be displayed in a dashboard.

### Predicted Model Generation

This system allows the user to set up some parameters to generate the model for the next period. Selections include:
Table containing the time-series data
Date field
Period of date

The predicted model gives the user an idea of what business environment to expect in the next period. If the current business model could not cope with the projected environment, then an alert can be activated and the manager would need to make necessary adjustment to the business operation.

### The Action Engine

The action engine updates the settings in the leaf BEs of the business framework to reflect the current value set for each BE. There are two options to this action engine: manual or automatic. The manual option would require the user to manually update the actual value of the BEs in the business framework, whereas automatic would trigger the action engine to update the actual value using the predicted value for each BEs. Note that this is only applicable to BE when the flag for act_manual_upd is set to true.

1. A method of determining the performance of a business process, the method comprising the steps of:
a) determining the plurality of business entities that comprise said business process;
b) for each of said plurality of business entities, identifying a relationship between said business entity and one or more further business entities from said plurality of business entities;
c) for each of said plurality of business entities and for each relationship identified in step b), quantifying a relationship between said business entities;
d) for one or more of said plurality of business entities, allocating a data value for said one or more business entities; and
e) determining the performance of said business process performance from the data values assigned to said one or more business entities in step d) and said business entity relationships quantified in step c).

2. A method as in claim 1, wherein in step a), said plurality of business entities comprises a hierarchical grouping of business entities.

3. A method as in claim 2, wherein in step a), said plurality of business entities comprises a first hierarchical grouping of business entities, said first hierarchical grouping of business entities comprising one or more business entities which represent a status or performance of a process parameter.

4. A method as in claim 3, wherein in step d) a data value is allocated to said one or more business entities from said first hierarchical grouping of business entities in accordance with one or more data values held in one or more data sources.

5. A method as in claim 2, wherein in step a), said plurality of business entities comprises a second hierarchical grouping of business entities, said second hierarchical grouping of business entities comprising one or more business entities which represent a tactical objective.

6. A method as in claim 5, wherein the data value for each of said one or more business entities from said second hierarchical grouping of business entities is determined by evaluating the relationship for the data value for each of said one or more further business entities identified in step b).

7. A method as in claim 5, wherein the data value for each of said one or more business entities from said second hierarchical grouping of business entities is determined by evaluating the relationship for the data value for one or more business entities from said first hierarchical grouping of business entities and/or one or more business entities from said second hierarchical grouping of business entities.

8. A method as in claim 5 wherein in step a), said plurality of business entities comprises a third hierarchical grouping of business entities, said third hierarchical grouping of business entities comprising one or more business entities which represent a strategic objective.

9. A method as in claim 8, wherein the data value for each of said one or more business entities from said third hierarchical grouping of business entities is determined by evaluating the relationship for the data value for each of said one or more further business entities identified in step b).

10. A method as in claim 8, wherein the data value for each of said one or more business entities from said second hierarchical grouping of business entities is determined by evaluating the relationship for the data value for one or more business entities from said first hierarchical grouping of business entities and/or one or more business entities from said second hierarchical grouping of business entities.

11. A method as in claim 4, wherein said one or more data values held in one or more data sources represent a business process parameter that can be controlled by the business process operator.

12. A method as in claim 4, wherein said one or more data values held in one or more data sources represent an external process parameter that can not be controlled by the business process operator.

13. A method as in claim 1, wherein in step c), the relationship(s) determined for each of said plurality of business entities are determined in accordance with a historical data set for each of said plurality of business entities.

14. A method of determining the performance of a business process, the method comprising the steps of:
a) determining the plurality of business entities that comprise said business process;
b) for each of said plurality of business entities, identifying a relationship between said business entity and one or more further business entities from said plurality of business entities;
c) for each of said plurality of business entities and for each relationship identified in step b), quantifying a relationship between said business entities;
d) assigning a desired value to a group of business entities that are indicative of the performance of said business process; and
e) determining values for the one or more other business entities such that when the relationships determined in step c) are evaluated, the results of that evaluation for the group of business entities that are indicative of the performance of said business process are substantially equal to those values assigned in step d).

15. A computer program product comprising computer executable code for carrying out the method of claim 1.

16. A system for of determining the performance of a business process, the system comprising;
one or more data storage means, said data storage means comprising data representing the value of each of a first plurality of business entities;
business logic means, said business logic means comprising data representing the value of each of a second plurality of business entities and a plurality of relationships between each business entity and one or more further business entities of said first plurality of business entities and/or one or more further business entities of said second plurality of business entities, wherein, in use, said value of each of said second plurality of business entities is derived from evaluating each of said relationships for each of said second plurality of business entities; and
wherein, in use, the performance of said business process is determined in accordance with said value of each of said second plurality of business entities.
